(19) United States
(12) Patent Application Publication
(10) Pub. No.: US 2015/0114311 A1
(43) Pub. Date: Apr. 30, 2015

(54) Dog harness

(71) Applicant: William Lynch, Green Brook, NJ (US)

(72) Inventor: William Lynch, Green Brook, NJ (US)

(21) Appl. No.: 13/998,406

(22) Filed: Oct. 30, 2013

(51) Int. Cl. A01K 27/00

(52) U.S. Cl. CPC A01K 27/002; A01K 27/003
USPC 119/792

(57) ABSTRACT

A dog harness comprising three flexible adjustable straps secured at a common midpoint, two adjustable flexible straps extending outwardly and under the forelegs of the dog and removably secured to a D-ring secured to the front of the collar of the dog underneath the dogs head, the third flexible adjustable strap having a D-ring secured to the end thereto for removable receipt of a leash, the harness controlling the pace and direction of the dog and also allowing the owner to control the head positioning of the dog without effecting a strain or choke to the dog's neck.

### BACKGROUND OF THE INVENTION

1. Field of the Invention

The present invention relates to a dog harness, and more particularly, to a dog harness which is cooperable with a dog collar and a leash to form an assembly for controlling the actions of a dog.

2. Description of the Prior Art

Dogs are popular pets. However, in suburban and urban areas, various statutes, codes and ordinances require the owner to have an identifier on the dog in the form of a dog collar, and also require that the owner have the dog restrained by a leash when appearing in public.

Typically the leash attaches to a dog collar, or in some instances, a harness which allows the owner to control the pace of the dog, the direction of travel of the dog, and to inhibit the dog from misbehaving.

When the leash is attached directly to the collar of the dog which is positioned about the neck, many deleterious factors can come into play with respect to the health of the dog. The dog's natural instinct is to strain against the leash and in doing so, the collar about the neck of the dog will oftentimes present a choking affect to the dog or it may place undue pressure and strain on the neck muscles, the airways and the nerves of the neck. Still further, a dog, straining at a leash attached to its collar may be successful in wresting the leash from the hands of the owner, and thus become free roaming in violation of local codes and ordinances.

In the past, efforts have been introduced to design strain reducing leashes or strain reducing harnesses which allow the owner to control the pace and direction of the dog and to maintain the dog under control while not placing undue strain or pressure on the neck of the dog, regardless of whether or not the dog is straining against the leash or not. Some of these attempts are evidenced by U.S. Pat. No. 4,964,369 to Sporn for “Strain Reducing Dog Harness”; U.S. Pat. No. 5,676,093 to Sporn for “Controllable Dog Harness and Leash Assembly”; U.S. Pat. No. 5,611,298 to Sporn for “Controllable Dog Harness and Leash Assembly”; U.S. Pat. No. 2,605,744 to Urbanski for “Dog Harness”; and to Krauss, U.S. Pat. No. 5,325,819 for “Non-Choking Strain Reducing Dog Harness”.

The shortcomings of the aforesaid patents vary. Some incorporate the collar in combination with a chest and body harness which transfers the pressure of the leash to the torso of the dog. Others eliminate collar per se and just have a body harness. These types of harnesses do not allow the owner to control the head of the dog and thus allow for distraction of the dog.

The disadvantages of most existing dog harnesses can be summed up with the following comments. Most dog harnesses require that they be wrapped around the dog creating a difficult situation in positioning the dog into the harness. In such situations, the dog in many instances can wiggle their way out of the harness.

The handler has little or no control with the dog utilizing the current back attached forms of harnesses. Still further the harnesses of the current state motivate the dog to pull, such as sled dogs and tracking dogs. Further, these type of harnesses wrap around the top and bottom of the dog's torso with a portion of the harness wrapped around the forward chest of the dog. By wrapping anything around the chest of the dog, the pressure of the pulling is not uncomfortable for the dog, but actually makes the dog very comfortable and encourages the pulling which is what we seek to avoid.

Some harnesses require the dog step into them and then be attached by a clip at the top of the dog's back. Step-in harnesses can be problematic in putting them on, particularly if the dog is uncooperative.

Front attached harnesses require the dog to be pulled off balance to make it move in the proper direction. The dog should be taught to move in a proper manner in a forward direction, by pulling the dog sideways with the front attached harnesses, the dog is not being trained to walk properly.

Finally, many of the prior art harnesses are standard harnesses and are not adjustable, therefore require different sizes as the dog grows and different sizes for different dogs.

Applicant's harness assembly is cooperative with an existing collar associated with a dog's neck and incorporates a harness which secures to the front of the collar and is attached to the torso harness. In this configuration, the leash, attached to the harness, allows the owner to control the pace of the dog, as well as the dog's head position.

Applicant's harness is very easy to position on the dog and it attaches to the existing collar and incorporates its own short leash which if of the appropriate length depending upon the physiognomy of the owner, keeps the dog in close proximity to the owner and walking in the correct forward manner. In this manner, if the dog begins to pull, tension placed on the short lease which is part of the harness will bring the dog's head down and prevent the pulling and excessive forward action and keep the dog walking in a straight manner. Luckily, the harness of the current invention comes in different sizes, but is fully adjustable so that it can be adjusted as the dog matures.

### OBJECTS OF THE INVENTION

An object of the present invention is to provide for a novel harness assembly cooperative with a dog collar for controlling a dog.

A further object of the present invention is to provide for a novel harness assembly, cooperative with the collar of a dog which allows the owner to control the head positioning of the dog while exercising.

A still further object of the present invention is to provide for a novel harness assembly cooperative with the collar of a dog which eliminates any undue strain, pressure or tension on the throat, windpipe, and nerves on the front of the dog's neck and transfers any pressure to the top or back of the neck where the muscles are stronger.

### SUMMARY OF THE INVENTION

A dog harness comprising three flexible adjustable straps secured at a common midpoint, two adjustable flexible straps extending outwardly and under the forelegs of the dog and removably secured to a D-ring secured to the front of the collar of the dog underneath the dogs head, the third flexible adjustable strap having a D-ring or O-ring, or similar attachment ring secured to the end thereto for removable receipt of a leash, the harness controlling the pace and direction of the dog and also allowing the owner to control the head positioning of the dog without effecting a strain or choke to the dog's neck.

### BRIEF DESCRIPTION OF THE DRAWINGS

These and other objects of the present invention will become apparent, particularly when taken in light of the following illustrations wherein:

FIG. 1 is a perspective view of the harness assembly;

FIG. 2 is a perspective view of the harness assembly of FIG. 1 illustrating the manner of adjustment of the harness assembly;

FIG. 3 is a perspective view of a dog with collar, having the harness assembly secured thereto; and

FIG. 4 is a top perspective view of a dog illustrating the positioning of the harness assembly on the back of the dog.

### DETAILED DESCRIPTION OF THE INVENTION

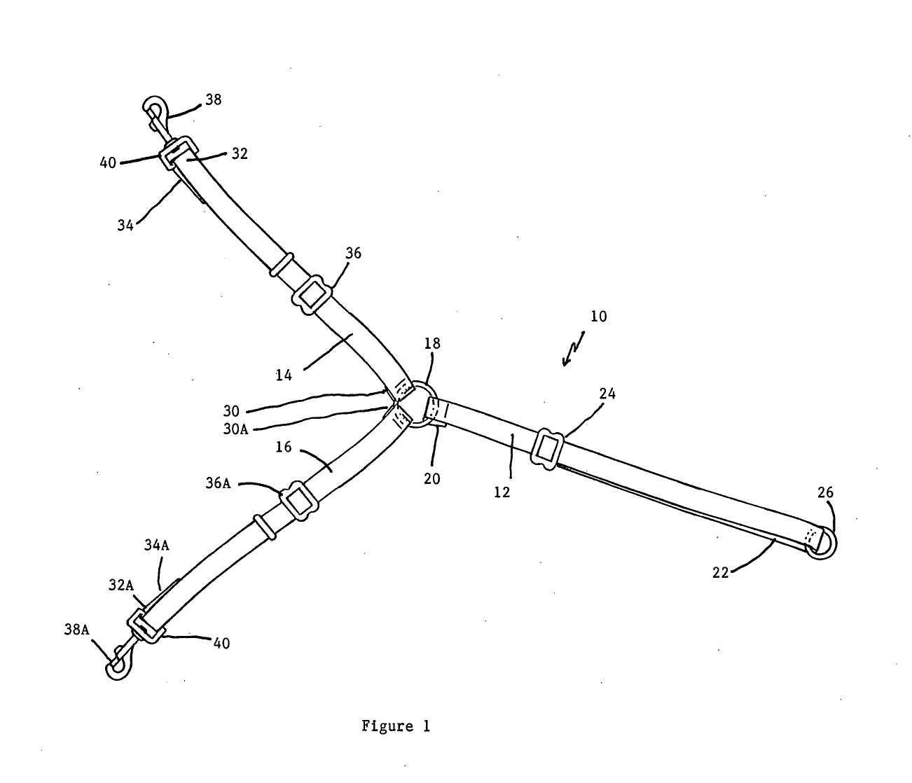

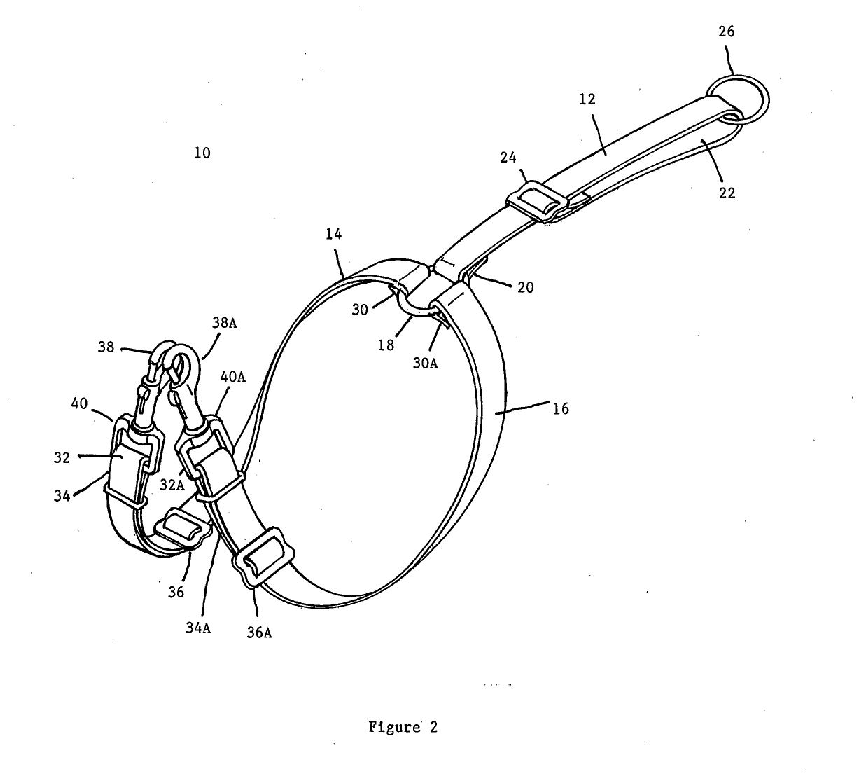

FIG. 1 is a perspective view of the harness assembly 10 and FIG. 2 is a perspective view of the harness assembly 10 illustrating the manner in which adjustment to the harness assembly 10 may be accomplished.

Harness assembly 10 comprises three straps 12, 14, and 16, radiating from a common focus point 18. The focus point 18 can comprise an O-ring, D-ring, or some form of snap ring which connects straps 12, 14, and 16 at a common point. This focus point when the harness assembly 10 is positioned on the dog, will be located on the back of the dog, preferably at a mid-point.

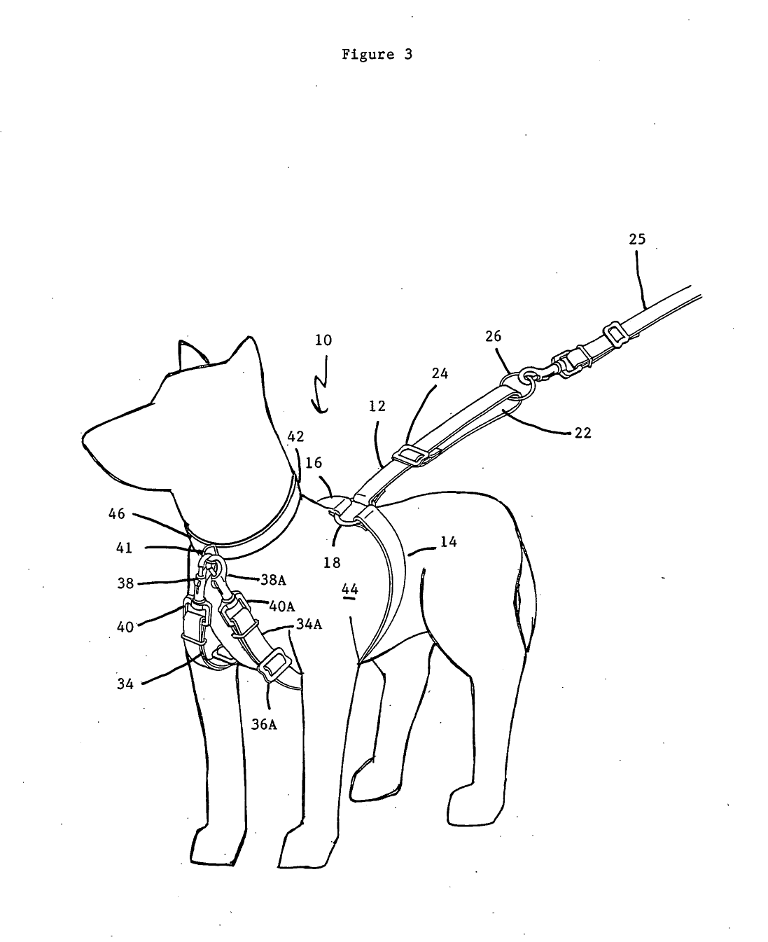

Strap 12 is the handle strap for the harness assembly 10. It consists of a braided strap, preferably fabricated from woven nylon or polyester of similar strength, the strap 12 having a permanently sewn loop 20 which is affixed to the focus point 18. Strap 12 is folded upon itself at the opposing end forming a 2-ply strap and forming a larger end loop 22, the woven nylon strap is secured to itself by means of an adjustable buckle member 24 which allows for the adjustment of the length of strap 12 from the focus point 18 to the end loop 22. Preferably, the adjustable end loop 22 would include an O-ring 26, which would allow the dog owner to secure an additional length of standard leash 25 (see FIG. 3) to strap 12 if required, depending upon the size of the dog fitted with the harness assembly 10, and the size and arm strength of the dog owner.

Also emanating from the focus point 18 are two identical straps 14 and 16, which will be referred to as the chest straps for the dog. Straps 14 and 16 are identical construction and comprise a fixed secured loop 30 and 30A secured to the focus point 18. The straps 14 and 16 are again preferably constructed from braided synthetic material such as woven fiber or polymer. Each strap consists of a length which is folded over upon itself at opposing end 32 and 32A to form a 2-ply strap and to form a loop 34 and 34A. The 2-ply strap is secured by means of an adjustable buckle 36 and 36A which allows for the dog owner to adjust the length of straps 14 and 16. The adjustable end loops and 34A of straps 14 and 16 have secured thereto a thumb activated snap hook 38 and 38A which may be secured directly to the adjustable loop 34 and 34A of straps 14 and 16 or may be secured to an O-ring or D-ring 40 and 40A which is secured to the adjustable loops 34 and 34A of straps 14 and 16. The snap hooks 38 and 38A can swivel and are operable by the thumb of an individual causing an opening allowing the snap hook to engage a D-ring, the release of the thumb pressure closing the aperture and securing the snap hook to the D-ring.

The D-ring 41 in question with respect to the snap hooks 38 and 38A, is positioned on the standard collar 42 of the dog 44 in the front portion 46 of the collar 42 beneath the dogs head. This position is illustrated in FIG. 3 which is a perspective view of the dog 44, with collar 42, having the harness assembly 10 secured thereto.

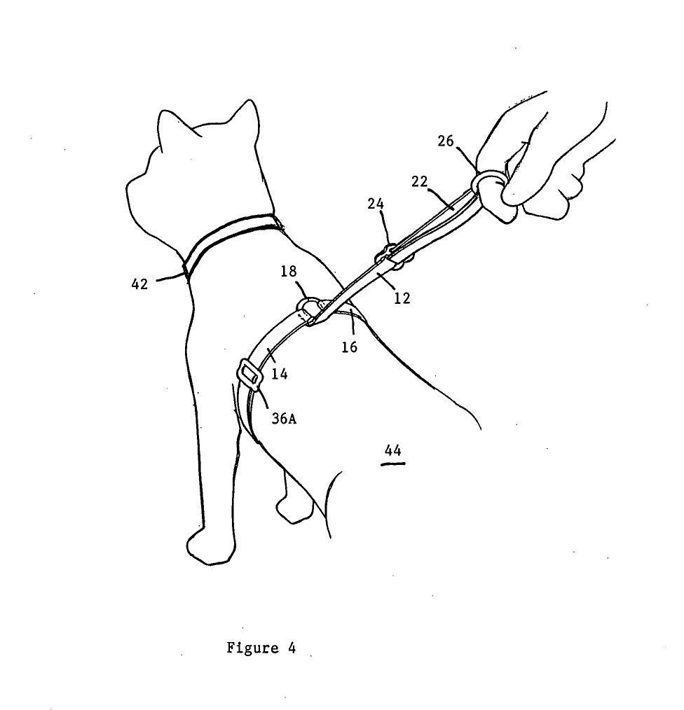

Additionally, FIG. 4 is a top perspective view of the dog 44 illustrating the positioning of the harness assembly from a top view and the location of the focus point 18 on the back of the dog.

In positioning the harness assembly 10 on the dog, particularly for the first time, loosen the straps 14 and 16. Position the focus point 18 on the back of the dog and extend straps 14 and 16 between the dogs front legs or forelegs, and up across the chest of the dog, attaching both of the snap hooks 38 and 38A to the D-ring 41 positioned on the front 46 of the collar 42 beneath the dogs head. Straps 14 and 16 should then be adjusted snugly utilizing buckles 36 and 36A so that the owner's hand can comfortably be positioned under the straps.

The hand strap, or strap 12 should then be adjusted with the O-ring 26 and dog's leash to obtain a comfortable distance between the hand of the owner and the dog which keeps the dog next to the owner. This may require an additional leash member 25 or depending upon the height of the owner and the dog, the loop 22 at the end of strap 12 can serve as the handle/leash combination.

In this construction, and installation, when the dog pulls at the harness, lift the hand strap, which in turn will apply pressure downwardly on the D-ring 41 on dog's collar 42, causing the dog to slow its pace.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A harness and collar assembly for the control and training of a dog, comprising:
a focus point in the form of a securing ring positioned centrally on the back of a dog, said securing ring having three resilient, flexible, adjustable straps extending there from, a first strap of said three straps extending rearwardly from said focus point and forming a leash member, said first strap comprised of braided nylon folded upon itself and secured by a slide fastener and forming an adjustable loop for an owner to grasp;
a second strap and a third strap of said three straps attached to said focus point, said second and third straps extending downwardly and forwardly from said focus point extending between the foreleg crotch of said dog on the right side and left side, and extend upwardly engaging a collar of said dog on a securing ring secured to the front of said collar below said dog's snout, said second and third straps secured to said securing ring by a quick release snap hook, the positioning and cooperation of said first strap and said second and third straps allows said owner to pullingly engage said first strap and consequently pull said dog's head downwardly if said dog has a tendency to pull on the leash, thereby training the dog to walk with a relaxed gait and in a straight line beside said owner.

2. The harness system in accordance with claim 1 wherein said first strap, second strap, and said third straps are comprised of woven braided polymer, or fabric filament which provides strength and flexibility, said first strap, said second strap, and said third strap being doubled over upon themselves and secured by a slide buckle allowing two plies of said straps to be adjustable in length to provide for a snug fit and to permit adjustment as said dog matures.

3. The harness system in accordance with claim 1 wherein said first strap is formed with an additional securing ring within said loop of said first strap allowing for attachment of a separate leash allowing for the extension of said leash member to accommodate the physique of said owner.

4. A harness assembly for use in training and walking a dog, the harness assembly for training the dog to adapt a proper walking gait and to avoid pulling on the leash and collar which applies undue tension and pressure to the dog's neck and throat, the improved harness assembly comprising:
a dog collar having a securing ring positioned in the front of the collar below said dog's snout;
a harness assembly, said harness assembly comprising a focus point positioned at a midpoint on the back of the dog, the harness assembly having a first, second, and third strap secured thereto and emanating there from, said first strap extending rearwardly and upwardly from said focus point and comprising a leash member for control of said dog, said second and third straps extending forwardly between the forelegs of said dog and between each of said forelegs and said crotch, said second and third strap members having formed at their forward ends, a snap hook for engagement with said securing ring positioned on said front of said collar of said dog;
said strap member forming said leash member, when restrained, places a downward force on said head of said dog by means of said second strap and said third strap and said snap hooks causing said dog to slow its gait and restrain from pulling on the leash.

5. The harness assembly in accordance with claim 4 wherein said first strap, said second strap, and said third strap are formed from braided woven polymer or fabric filament providing a flexible strap.

6. The harness assembly in accordance with claim 4 wherein said first strap, said second strap, and said third strap are folded upon themselves and secured together in a two-ply relationship by means of a slide buckle, said slide buckle allowing for adjustment of the lengths of said first strap, said second strap, and said third strap to accommodate the growth of said dog and different sized dogs.

7. The harness assembly in accordance with claim 4 wherein said first strap forming said leash member is formed with a loop utilizing said slide buckle for grasping control by a handler.

8. The harness assembly in accordance with claim 7 wherein said loop and said first strap has secured thereto a securing ring for the receipt of an additional leash member for further extending the length of the leash.

9. A harness assembly cooperative with a dog collar for the control and training of a dog, comprising:
a focus point in the form of a securing ring positioned centrally on the back of a dog, said securing ring having three resilient, flexible straps extending there from, a first strap of said three straps extending rearwardly from said focus point and forming a leash member, said first strap folded upon itself and secured by a slide fastener and forming an adjustable loop for an owner to grasp;
a second strap and a third strap of said three straps attached to said focus point, said second and third straps extending downwardly and forwardly from said focus point extending between the foreleg crotch of said dog on the right side and left side, and extend upwardly engaging a collar of said dog on a securing ring secured to the front of said collar below said dog's snout, said second and third straps secured to said securing ring by a quick release snap hook, the positioning and cooperation of said first strap and said second and third straps allows said owner to pullingly engage said first strap and consequently pull said dog's head downwardly if said dog has a tendency to pull on the leash, thereby training the dog to walk with a relaxed gait and in a straight line beside said owner.

10. The harness system in accordance with claim 9 wherein said first strap, second strap, and said third straps are comprised of woven braided polymer or fabric filament which provides strength and flexibility, said first strap, said second strap, and said third strap being doubled over upon themselves and secured by a slide buckle allowing two plies of said straps to be adjustable in length to provide for a snug fit and to permit adjustment as said dog matures.

11. The harness system in accordance with claim 9 wherein said first strap is formed with an additional securing ring within said loop of said first strap allowing for attachment of a separate leash allowing for the extension of said leash member to accommodate the physique of said owner.
